(19) United States
(12) Patent Application Publication
(10) Pub. No.: US 2007/0267489 A1
(43) Pub. Date: Nov. 22, 2007

(54) Door with electromagnetic locking mechanism having increased level of security

(76) Inventor: Aleksandr Borodulin, Campbell, CA (US)

Correspondence Address: Aleksandr Borodulin, 247 Cherry Lane, Campbell, CA, 95008, US

(21) Appl. No.: 11/436,087

(22) Filed: May 18, 2006

(51) Int. Cl. G06K 5/00

(52) U.S. Cl. 235/382

(57) ABSTRACT

A door with an electromagnetic locking mechanism having an increased level of security, which is provided with an electromagnetic locking mechanism activated from a an electronic lock-control unit located in a position hidden from a viewer that looks at the outer side of the door, e.g., inside the material of the door panel or on the inner side of the door. The electronic lock-control unit activates the electromagnetic lock when it receives a pre-coded modulated electromagnetic signals from a pre-coded card when the latter is brought to a position of electromagnetic coupling with the electronic lock-control unit.

### FIELD OF THE INVENTION

The present invention relates to a door with an electromagnetic locking device, and more particularly, to a door with an electronically controlled electromagnetic lock having an increased level of security.

### BACKGROUND OF THE INVENTION

There exist a great variety of door locks that can be roughly divided into mechanical and electrically or electronically operated door locks. Normally, the position of the mechanical lock is seen from the outer side of the door, and, therefore, the lock can be easily found and opened by a burglar.

The electronically-operated door locks utilize various means such as codes entered though a small input keyboard or card keys. The last group includes most widely used magnetic stripe cards, especially in hotels. Such a card is encoded by means of bars of magnetized and unmagnetized material on the strip forming the binary code. This is achieved by changing the orientation of the north and south poles of the magnetic materials and using the transition distances between the poles to store the data. The magnetized and non-magnetized areas are represented by the numbers 1 and 0 to form the appropriate binary code which is deciphered by the reader on presentation. Such cards are manufactured as standard or high coercivity that is a measure of their ability to resist corruption by stray magnetic fields, with high coercivity cards being almost incorruptible. In operation the magnetic stripe information is read by swiping it through a reader or by inserting it into position in a slot provided on the external part of the lock.

For example, U.S. Pat. No. 5,591,950 issued in 1997 to J. Imedio-Ocana discloses a programmable electronic lock that provides security among multiple users, allows independent use by multiple users of different types, and is modularly adaptable to various applications. Security is provided by the automatic updating of a lock code if an inserted card's key code bears a predetermined relation to the stored lock code. The invention allows multiple types of users to access a given lock without affecting lock codes associated with other types or invalidating the stored lock codes of other users of the same type. For example, in a hotel room lock, a maid's key will not change the code for a guest's key, and other maid's keys will still open a lock after a first maid has accessed the lock if their lock codes are stored in the lock.

A drawback of the door lock of U.S. Pat. No. 5,591,950 is that the lock of such type is advantageous for use by multiple users and is too expensive and complicated for use in conventional single-family apartments or houses. Position of the lock is also visible.

Chinese Patent No. 1587614 issued in 2005 to B. Zhao discloses a concealed electronic cipher lock which is composed of panel, turnover panel, display, the keyboard of cipher lock, switch and operation instructions. The turnover panel is established in the panel and the two are linked with a bearing on which card spring is installed firmly. The turnover panel can be turnovered around the bearing. When it is closed, the keyboard of cipher lock and display are concealed behind the turnover panel and inside the panel and when it is open, the two are parallel to the level and facing up. This invention improves the secret and safety performance of the electronic cipher lock, and the structure of turnover panel is easy for use to input the password which needn't the user beading over or squatting down.

Chinese Patent CN No. 1355369 issue in 2002 to Y. Zhu discloses a safe where position of the locks is hidden and is not seen from the outer side. A hidden lock-controlled antitheft intelligent safe is composed of safe body, gate sash, gate frame and mechanical locking device. Several bosses with bolt holes of lock are arranged at edge surface of gate sash. The recess with bolt holes are arranged at internal side of gate frame. The locking hook is combined with gate frame. The gate and gate frame are closely engaged and locked via the said bosses and recess, resulting in safety locking. It can also be combined with an electronic system and software for cipher locking and automatic alarming.

A disadvantage of all locking devices described above as well as of others known to the applicant is that they show the location either of a keyhole for mechanical locks or of a slot for insertion of the electromagnetic card. Therefore, a burglar can find the position of the lock and open it either by mechanical or electromagnetic means.

### SUMMARY

It is an object of the invention to provide a door with a simple and reliable door locking mechanism that is hidden from view on the outer side of the door. It is another object to provide a door with a door lock that consists of a electro-mechanical locking mechanism and an electronic lock-control unit located in a hidden position inside the door. It is still another object to provide a door with the door lock of the aforementioned type that can be opened by interacting a pre-coded card with a hidden electronic lock-control unit located in a position known only to an authorized person.

The door of the invention with an electromagnetic door lock consists of a electro-mechanical part (that may comprise a mortise-type lock, hasp lock or a door lock of another type, which is not seen from the outer side of the door) and an electronic part that controls operation of the electro-mechanical lock. The invention is based on the principle that not only a position of the electro-mechanical part is not seen from the outer side of the door but also a position of the data input part unit of the electronic part, which is hidden from an externally located viewer. The electronic lock-control unit of the lock is placed in a hidden location inside the door that is known only to an authorized person. This unit is designed for receiving the coded data through an electromagnetic coupling with an externally located electromagnetic card and can receive the data from this pre-coded card only when this card is in a predetermined proximity position, e.g., at a distance of a few centimeters from the aforementioned unit, or in direct contact with the outer door surface and in alignment with the aforementioned unit. The pre-coded key card, which is similar to a security ID card, contains an electronic chip, which is comprised of an electrically-erasable programmable read-only memory (EEPROM) for storing information relating at least to a door opening code, although it may contain some other information, e.g., regarding the allowable time of access, or the like. The card also contains a digital control, a chip RF antenna with a chip RF interface for interaction with the antenna of the electronic lock-control unit. The digital control unit may be comprised of a control and arithmetic logic unit, an EEPROM interface, and a coding unit. Energy and data are transferred via the RF antenna, which consists of a coil with a few turns directly connected to the card. The RF-interface includes modulator/demodulator, rectifier, clock generator, and other units. If the time of access has a predetermined duration, e.g., for several months, the control and arithmetic logic unit assists in decrementing the values stored in a special redundant format. The coding unit secures data exchange. The EEPROM may be the one with 1 Kbyte organized in 16 sectors with 4 blocks each. A block contains 16 bytes. The last block of each sector may contain two secret keys and programmable access conditions for each block in this sector. The card may have the following dimensions: Length: 85 mm; width: 54 mm; thickness: 1.25 mm. The card is made of plastic with all electrical components embedded. The door itself can be made from any appropriate material, e.g., wood or even metal. In the case of metal, however, the portion of the door that corresponds to the position of the input data unit must be made from a material permeable to electromagnetic radiation, e.g., from wood, plastic, or glass ceramic. In any case, the outer surface of the door is masked with a smooth homogeneous material that hides the secret location of the lock and the electronic lock-control unit. If necessary, the outer surface may have a decorative pattern that can be used to facilitate location of the hidden lock control for the authorized user. The electromechanical part contains a solenoid connected to the tail portion of the deadbolt of the door lock. The solenoid terminals are electrically connected to the electronic lock-control unit by lead wires hidden inside the door. Once the door lock is opened, further control of the lock (manual mechanical closing or electromagnetic closing) is carried out by the user from inside of the premises.

### BRIEF DESCRIPTION OF THE DRAWINGS

FIG. 1 is a general front view of a door of the invention equipped with the hidden lock.

FIG. 2 is a general front view of a door of the invention equipped with the hidden lock, where finding of hidden location of the lock control by an authorized person is facilitated by using a pattern on the outer side of the door.

FIG. 3 is a top view of a pre-coded card with the upper layer of the card removed for exposing arrangement of the card components.

FIG. 4 is a three-dimensional view of a electronic lock-control unit of the door lock of the invention.

FIG. 5 is an example of an electro-mechanical locking mechanism of the invention in a locked position.

FIG. 6 is the electro-mechanical locking mechanism of FIG. 5 in an unlocked position.

### DETAILED DESCRIPTION OF THE INVENTION

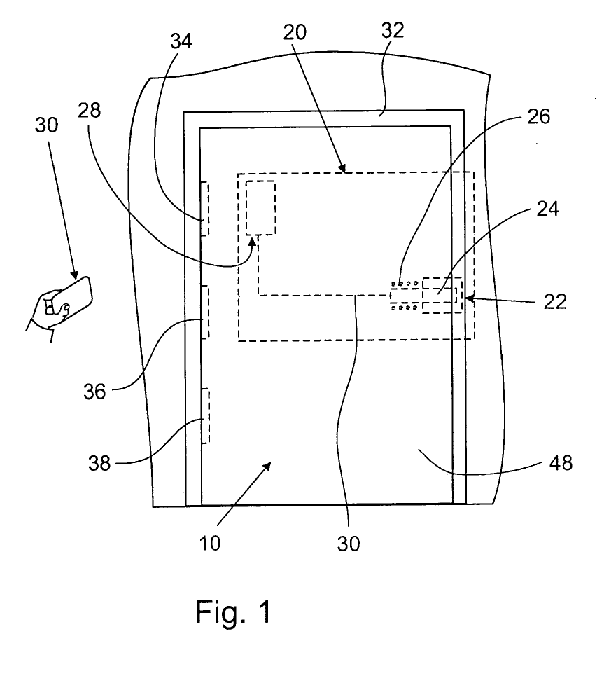

A general front view of a door of the invention equipped with the hidden lock is shown in FIG. 1. In this drawing, reference numeral 10 designates a door panel, 22 designates an electro-mechanical part with a deadbolt 24 and a solenoid 26 that provides reciprocating movements of the deadbolt 24 between the withdrawn or door-open position and the forward door-locking position, reference numeral 28 designates an electronic control part of the lock 20 made in the form of a electronic lock-control unit, and reference numeral 30 designates lead wires that connect the solenoid 26 with the electronic lock-control unit 28.

The invention is based on the principle that not only a position of the electro-mechanical part 22 is not seen from the outer side of the door panel 10 but also a position of the electronic lock-control unit 28 of the hidden lock from an externally located viewer. The electronic lock-control unit 28 of the door lock is placed in a hidden location inside the door panel 10, which is known only to an authorized person. This unit 28 is designed for receiving the coded data through an electromagnetic coupling with a pre-coded card 30 when this card is placed into a predetermined proximity position, e.g., a few centimeters away from the unit 28 on the outer side of the door panel, or in direct contact with the outer door panel surface and in alignment with the aforementioned unit 28. The door panel 10 may have any construction that can be attached to a door frame 32 by hinges 34, 36, and 38. The position of the hinges also is hidden from an external viewer. Since the aforementioned units of the door lock system are hidden from the external view, in FIG. 1 they are shown by broken lines.

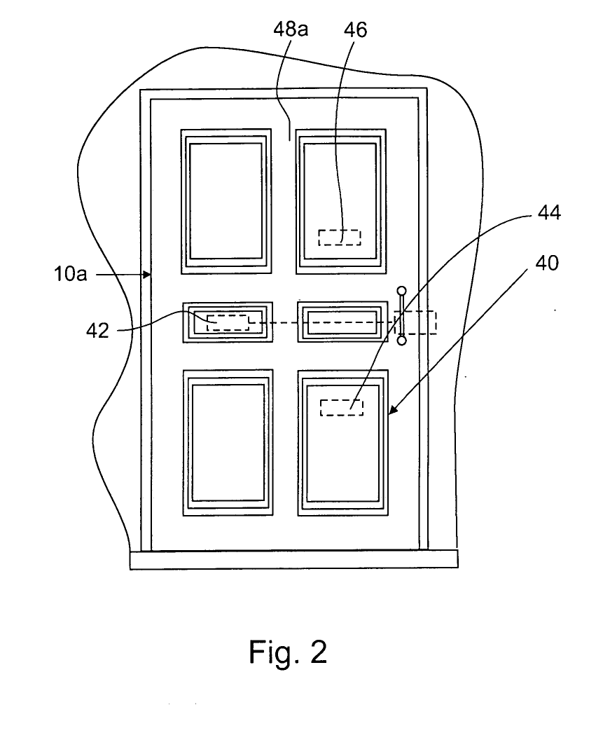

The door panel surface may be smooth and homogeneous without any indications to the positions of the door-lock components, as shown in FIG. 1, or, if necessary, the door panel 10a may have an external decorative pattern, e.g., of the type shown in FIG. 2 and designated by reference numeral 40. The pattern 40 may be used by the owner of the pre-coded card 30 for facilitating location of the hidden electronic lock-control unit 28, position of which on the pattern is known only to an a card owner. In the embodiment of FIG. 2, reference numerals 42, 44, and 46 show examples of positions suitable for location of the electronic lock-control unit 28.

The door panel 10, or 10a, itself can be made from any appropriate material, e.g., wood or even metal or metal alloy, such as aluminium, aluminum alloy, steel, etc. In the case of metal, however, the portion of the door panel that corresponds to the position of the input data unit 28 must be made from a material permeable to electromagnetic radiation, e.g., from wood, plastic, or glass ceramic. In any case, the outer surface of the door panel is masked with a smooth homogeneous material 48 that hides the secret location of the lock and the electronic lock-control unit 28 (FIG. 1) or with a patterned material 48a (FIG. 2) that facilitates location of the lock control by an authorized person.

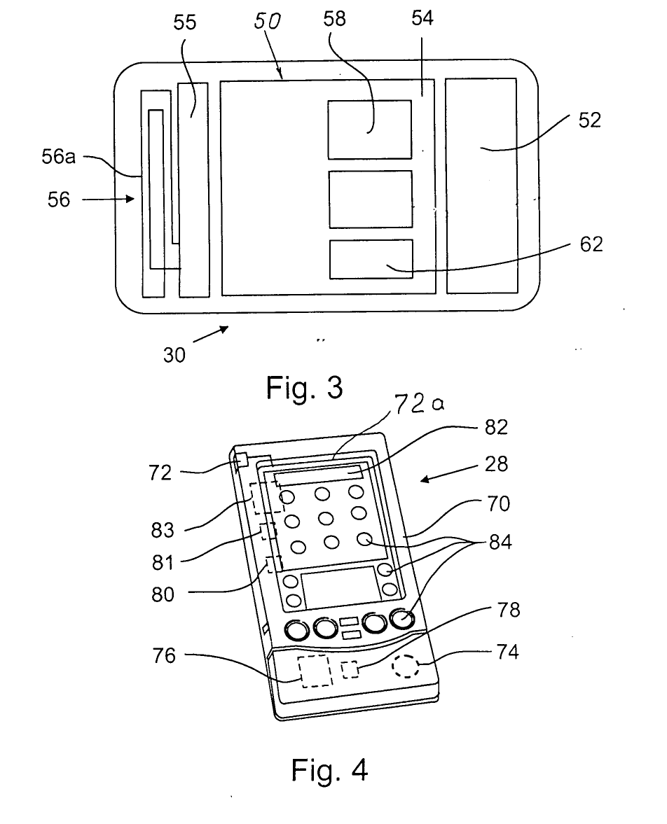

The structure of the pre-coded card 30 is shown in FIG. 3, which is a top view of the card with the upper layer of the card removed for exposing arrangement of the card components. Such cards are known and produced, e.g., by Phillips Semiconductors. The card 30 contains an electronic chip 50, which is comprised of an electrically-erasable programmable read-only memory (EEPROM) 52 for storing information relating to an entrance password, and, if necessary, to the card owner. The card also contains a digital control 54, a chip RF antenna 56 with a chip RF interface 55. The digital control unit 54 may be comprised of a control and an arithmetic logic unit 58, an EEPROM interface, and a coding unit 62. Energy and data are transferred via the RF antenna 56 which consists of a coil 56a (FIG. 3) with a few turns directly connected to the card. The RF-interface includes modulator/demodulator, rectifier, clock generator, and other units (not shown). The control and arithmetic logic unit 58 assists in incrementing and decrementing the values stored in a special redundant format. For example, these units can be used when the use of the card 30 is limited by the duration of the use time, e.g., three months, or by the number of door openings.

The coding unit 62 secures data exchange. The EEPROM 52 may be the one with 1 Kbyte organized in 16 sectors with 4 blocks each. A block contains 16 bytes. The last block of each sector may contain two secret keys and programmable access conditions for each block in this sector. The codes of the card 30 can be changed, e.g., by inputting new data via a contactless interaction with a below-described electronic lock-control unit 28. The card 30 may have the following dimensions: Length: 85 mm; width: 54 mm; thickness: 1.25 mm. The card is made of plastic with all electrical components embedded.

A general schematic view of the electronic lock-control unit 28 is shown in FIG. 4. The unit may have dimensions suitable for mounting thereof inside the material of the door panel. The unit 28 has a casing 70 molded from a durable plastic and contains an RF antenna 72 for contactless interaction and data transmission between the unit 28 and the respective pre-coded card 30, and a coil 72a connected to the RF antenna. Among other things, the casing also contains a power supply battery 74, an internal 1 MB memory unit 76 for data capture application, a real time clock 78, authentification unit 80, the value block 81, the read/write block 83, and an interface for data loading and unloading. The card 30 can be recoded and new data can be introduced into the card and stored in its memory device. If necessary this can be done with the use of a remotely located read/write station that will have essentially the same construction as the one shown in FIG. 4. For convenience, the recoding of the pre-coded card 30 can be made with the electronic lock-control unit 28 that incorporates in it the functions of the recoding device. For this purpose, it is necessary to provide access to the antenna 72 from the inner side of the door panel, as well as to an LCD display 82 and a data input keypads 84 that should be provided for read/write purposes.

It should be noted that the electronic lock-control unit 28 is an active unit that is constantly energized by its power supply battery 74, while the pre-coded card 30 is a passive unit, and the coil of its antenna 56 (FIG. 3) is energized by the electromagnetic signals of the electronic lock-control unit 28 through electromagnetic interaction with its antenna 72.

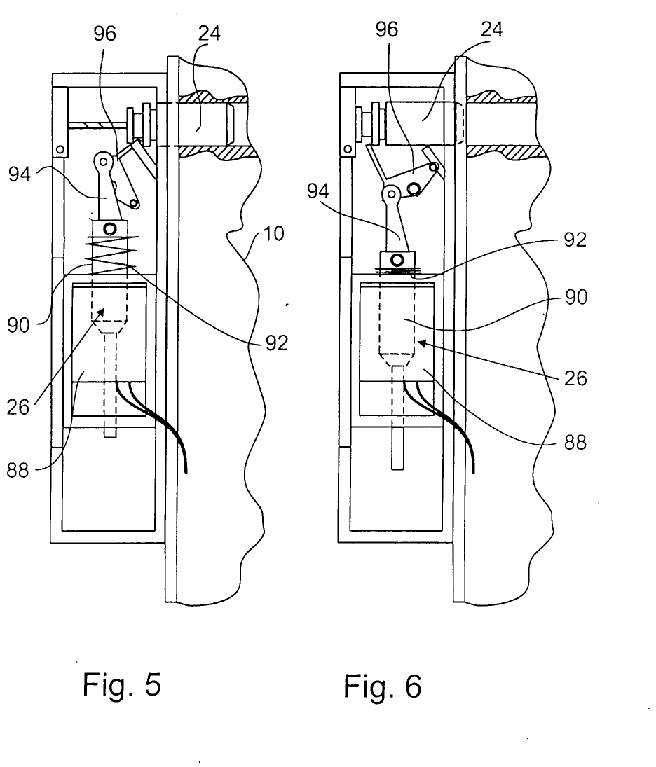

An electro-mechanical lock 22 (FIG. 1) suitable for the invention may be any known door lock having a deadbolt 24 moveable between the lock-closed and lock-opened positions, e.g., by means of a solenoid, such as the one shown in FIG. 1 and designated by reference numeral 26. An example of such a mechanism is shown in FIGS. 5 and 6, where FIG. 5 illustrates the lock in a door-closed position, and FIG. 6 illustrates the lock in a door-open position. As shown in these drawings, the solenoid 26 consists of an electromagnetic coil 88, a plunger 90, and an expansion spring 92.

The deadbolt 24 of the door lock 22 is connected with the external end of the plunger 90 via an articulated linking mechanism 92 that consists of pivotally connected levers 94 and 96. An arm 98 of the link 96 is inserted into an annular groove 100 formed on the tail portion of the deadbolt 24 that can slide in the direction X (FIGS. 5 and 6) for entering the guide sleeve 102 inserted into the door panel 10 or 10a and arranged coaxially with the deadbolt 24.

In the embodiment of FIGS. 5 and 6, the expansion spring 92 normally holds the plunger 90 in the position extended position shown in FIG. 5, e.g., extended from the electromagnetic coil 88, so that the link 96 shifts the deadbolt to the right in the view of FIG. 5, i.e., into the sleeve 102, for locking the door panel 10.

When the pre-coded card is placed into the position of interaction with the electronic lock-control unit 28 by approaching it close to the unit 28 without contact with the door panel or by applying the card 30 onto the outer surface 48 of the door panel in alignment with the unit 28, the antenna 58 of the pre-coded card 30 begins to receive, in a manner known in the art, electromagnetic waves from the electronic lock-control unit 28 through the unit antenna 72. The aforementioned electromagnetic waves induce an electric current in the passive coil 56a of the card antenna 56. This current activates the electronic components of the electronic chip 50, i.e., the EEPROM 52, the digital control 54, and the coding unit 62. As a result, the coding unit 62 begins to radiate through the antenna 56 towards the electronic lock-control unit 28 responsive electromagnetic signals modulated in accordance with the coded data. The responsive signals are compared with the codes stored in the memory of the electronic lock-control unity 28, and if the codes coincide, the unit 28 sends through the lead wires 30 control signals to the coil 88 of the solenoid 26, whereby the coil is energized and pulls the plunger 90 into the coil 88 against the force of the expansion spring 92. While the plungers 90 moves into the coil 88, the spring is compressed, the link 94 turns in the counter-clockwise direction to the position shown in FIG. 6, the arm 96 also turns in the counter-clockwise direction, and shifts the deadbolt 24 to the left, i.e., out from the sleeve 102 to the unlocked position of the door lock.

After the door is opened, the deadbolt 24 may be fixed in the opened position by a retaining mechanism, e.g., by a snapping device (not shown), so that removal of the card 30 from the position of electromagnetic engagement with the electronic lock-control unit 28 will not change the open position of the electromechanical lock, and the latter can be closed under the action of the expansion spring 92 when the user releases the deadbolt from the fixation by the retaining mechanism.

Thus, it has been shown that the invention provides a simple and reliable door locking mechanism that is hidden from view on the outer side of the door, consists of a electro-mechanical locking mechanism and an electronic lock-control unit located in a hidden position inside the door panel, and can be opened by interacting a pre-coded card with a hidden electronic lock-control unit located in a position known only to an authorized person.

Although the invention has been shown and described with reference to specific embodiments, it is understood that these embodiments should not be construed as limiting the areas of application of the invention and that any changes and modifications are possible, provided these changes and modifications do not depart from the scope of the attached patent claims. For example, the door panel may be made from materials other than wood or metal, provided that material and construction of the door panel do not violate conditions of electromagnetic interaction between the card and the electronic lock control unit. The electromagnetic lock may have a structure different from the one shown in FIGS. 5 and 6. For example, a compression spring can be used instead of the expansion spring, and the lock can normally be maintained in the open position and activated for locking by releasing a springing mechanism.

1. A door with an electromagnetic locking mechanism having an increased level of security comprising:
a door panel having an outer side and an inner side;
an electromagnetic locking mechanism comprising an electromagnetic door lock attached to said door panel in a position hidden from a view on said outer side and an electronic lock-control unit attached to said door panel in a position hidden from a view on said outer side and electrically connected to said electromagnetic locking mechanism, said electronic lock-control unit having means for radiating electromagnetic waves and means for receiving pre-coded modulated electromagnetic signals that activate said electromagnetic door lock; and
a pre-coded card having means for generating an electric current in response to said electromagnetic waves, when said pre-coded card is in a position of electromagnetic coupling with said electronic lock-control unit, and signal generating means for generating said pre-coded modulated electromagnetic signals when said signal generating means are energized by said current.

2. The door of claim 1 with an electromagnetic locking mechanism having an increased level of security, wherein said electromagnetic door lock has a deadbolt and a solenoid connected to said deadbolt for moving said deadbolt between a closed position and open position of said electromagnetic door lock.

3. The door of claim 2 with an electromagnetic locking mechanism having an increased level of security, wherein said electronic lock-control unit is located in a position selected from position on said inner side of said door panel and in a inside said door panel in location invisible from said inner side and from said outer side.

4. The door of claim 3 with an electromagnetic locking mechanism having an increased level of security, wherein said means for generating an electric current in response to said electromagnetic waves comprises a coil and a card antenna connected to said coil, and wherein said signal generating means for generating said pre-coded modulated electromagnetic signals comprises at least an electrically-erasable programmable read-only memory, a digital control, a coding unit, said card coil, and said card antenna.

5. The door of claim 2 with an electromagnetic locking mechanism having an increased level of security, wherein said means for receiving said pre-coded modulated electromagnetic signals comprise at least a control unit coil, an RF antenna connected to said RF coil, an electric power source connected to said control unit coil

6. The door of claim 5 with an electromagnetic locking mechanism having an increased level of security, wherein said electronic lock-control unit further comprises an internal memory unit for data capture application, a real time clock, a read/write block, and an interface for data loading and unloading.

7. The door of claim 6 with an electromagnetic locking mechanism having an increased level of security, wherein said electronic lock-control unit further comprises an LCD display.

8. The door of claim 3 with an electromagnetic locking mechanism having an increased level of security, wherein said means for receiving said pre-coded modulated electromagnetic signals comprise at least a control unit coil, an RF antenna connected to said RF coil, an electric power source connected to said control unit coil.

9. The door of claim 8 with an electromagnetic locking mechanism having an increased level of security, wherein said electronic lock-control unit further comprises an internal memory unit for data capture application, a real time clock, a read/write block, and an interface for data loading and unloading.

10. The door of claim 9 with an electromagnetic locking mechanism having an increased level of security, wherein said electronic lock-control unit further comprises an LCD display.

11. The door of claim 4 with an electromagnetic locking mechanism having an increased level of security, wherein said means for receiving said pre-coded modulated electromagnetic signals comprise at least a control unit coil, an RF antenna connected to said RF coil, an electric power source connected to said control unit coil.

12. The door of claim 11 with an electromagnetic locking mechanism having an increased level of security, wherein said electronic lock-control unit further comprises an internal memory unit for data capture application, a real time clock, a read/write block, and an interface for data loading and unloading.

13. The door of claim 12 with an electromagnetic locking mechanism having an increased level of security, wherein said electronic lock-control unit further comprises an LCD display.

14. The door of claim 1 with an electromagnetic locking mechanism having an increased level of security, wherein said door panel has a pattern on said an outer side and wherein said position hidden from a view on said outer side is related to said pattern in order to facilitate location of said electronic lock-control unit.

15. The door of claim 14 with an electromagnetic locking mechanism having an increased level of security, wherein said electromagnetic door lock has a deadbolt and a solenoid connected to said deadbolt for moving said deadbolt between a closed position and open position of said electromagnetic door lock

16. The door of claim 15 with an electromagnetic locking mechanism having an increased level of security, wherein said electronic lock-control unit is located in a position selected from position on said inner side of said door panel and in a inside said door panel in location invisible from said inner side and from said outer side.

17. The door of claim 16 with an electromagnetic locking mechanism having an increased level of security, wherein said means for generating an electric current in response to said electromagnetic waves comprises a coil and a card antenna connected to said coil, and wherein said signal generating means for generating said pre-coded modulated electromagnetic signals comprises at least an electrically-erasable programmable read-only memory, a digital control, a coding unit, said card coil, and said card antenna.

18. The door of claim 15 with an electromagnetic locking mechanism having an increased level of security, wherein said means for receiving said pre-coded modulated electromagnetic signals comprise at least a control unit coil, an RF antenna connected to said RF coil, an electric power source connected to said control unit coil.

19. The door of claim 18 with an electromagnetic locking mechanism having an increased level of security, wherein said electronic lock-control unit further comprises an internal memory unit for data capture application, a real time clock, a read/write block, and an interface for data loading and unloading.

20. The door of claim 19 with an electromagnetic locking mechanism having an increased level of security, wherein said electronic lock-control unit further comprises an LCD display.
